(19) United States
(12) Patent Application Publication
(10) Pub. No.: US 2021/0312227 A1
(43) Pub. Date: Oct. 7, 2021

(54) SYSTEM AND METHOD FOR DETECTING ANNOTATION ERRORS

(71) Applicant: Samsung Electronics Co., Ltd., Suwon-si (KR)

(72) Inventors: Ghazaleh Moradiannejad, Los Gatos, CA (US); Stefano Marzani, Mountain View, CA (US); Giuseppe Andrea Caliandro, San Francisco, CA (US)

(21) Appl. No.: 16/868,163

(22) Filed: May 6, 2020

Related U.S. Application Data
(60) Provisional application No. 63/004,118, filed on Apr. 2, 2020.

(51) Int. Cl. G06K 9/62; G06T 7/11

(52) U.S. Cl. CPC G06K 9/6227; G06T 7/11; G06T 2207/20084; G06T 2207/20081; G06K 9/6256

(57) ABSTRACT

A system and method for detecting annotation errors are disclosed. A processor receives an image that includes a first annotation, and identifies a first classifier associated with the first annotation. The processor invokes the first classifier to classify the first annotation, where the first annotation is classified with a first label. The processor transmits a message in response to classifying the first annotation with the first label, where the message is for prompting an update to the first annotation. The processor receives the image with an updated first annotation, and saves the image with the updated first annotation in a data storage device. The image may be for training an artificial intelligence machine for conducting an automated task.

### CROSS-REFERENCE TO RELATED APPLICATION(S)

The present application claims priority to and the benefit of U.S. Provisional Application No. 63/004,118, filed Apr. 2, 2020, entitled “AUTOMATIC SYSTEM TO DETECT ANNOTATION ERRORS,” the entire content of which is incorporated herein by reference.

### FIELD

One or more aspects of embodiments according to the present disclosure relate training artificial intelligence machines, and more particularly, to automatically detecting annotation errors in images used for training such machines.

### BACKGROUND

In order to train an artificial intelligence (AI) machine, such as one used for autonomous/self-driving cars, the AI machine is generally trained with images of scenes around the vehicle. The images may contain objects that the AI machine may be taught to recognize, such as, for example, objects on a street that a self-driving car may encounter while driving, the street itself, and/or the like. In this regard, the objects in the images may be annotated/labeled in order to make the objects recognizable to machines. The annotated images may then be provided to the AI machine for training. Once trained, the AI machine may be able to determine, for example, whether a static or moving object on the street is another car or a pedestrian.

The accuracy of an algorithm used by the AI machine to detect objects in the environment surrounding the AI machine may depend on the accuracy of the annotations of the images that are used for training the AI machine. Annotations for training are often generated by humans who may make mistakes. Generating and proofing the annotations may often be a bottleneck for AI development and training.

Accordingly, what is desired is a system and method for automatically checking annotated images for annotation errors to allow such errors to be corrected. Doing so may help reduce at least some of the bottleneck of AI development and training.

### SUMMARY

Embodiments of the present disclosure are directed to a method for detecting annotation errors. A processor receives an image that includes a first annotation, and identifies a first classifier associated with the first annotation. The processor invokes the first classifier to classify the first annotation, where the first annotation is classified with a first label. The processor transmits a message in response to classifying the first annotation with the first label, where the message is for prompting an update to the first annotation. The processor receives the image with an updated first annotation, and saves the image with the updated first annotation in a data storage device. The image may be for training an artificial intelligence machine for conducting an automated task.

In one embodiment, the first annotation includes at least one of graphics data or sensor data.

In one embodiment, the first classifier includes a binary classifier configured to classify annotations with the first label or a second label, wherein the first label is indicative of an incorrect annotation, and the second label is indicative of a correct annotation, and wherein the updated first annotation is classified with the second label.

In one embodiment, the first classifier includes a neural network.

In one embodiment, the artificial intelligence machine is hosted in a self-driving car, and the automated task includes a self-driving task.

In one embodiment, the image includes a second annotation, and the method further comprising: identifying, by the processor, a second classifier associated with the second annotation, the second classifier being different from the first classifier; and invoking, by the processor, the second classifier to classify the second annotation, wherein the second annotation is classified with the first label, and wherein the message includes information on the second annotation for prompting an update to the second annotation.

In one embodiment, the method further comprises learning, by the processor, a feature of the image in response to classifying the first annotation with the first label; and associating the learned feature with tag data.

In one embodiment, the learning of the feature includes invoking a neural network.

In one embodiment, the tag data includes a keyword associated with the learned feature of the image.

In one embodiment, the method further includes recognizing, by the processor, the feature in a second image; associating, by the processor, the tag data to the second image; and transmitting, by the processor, a message in response to associating the tag data to the second image.

Embodiments of the present disclosure are further directed to a system for detecting annotation errors. The system includes a processor and memory, where the memory contains instructions that, when executed by the processor, cause the processor to: receive an image, wherein the image includes a first annotation; identify a first classifier associated with the first annotation; invoke the first classifier to classify the first annotation, wherein the first annotation is classified with a first label; transmit a message in response to classifying the first annotation with the first label, wherein the message is for prompting an update to the first annotation; receive the image with an updated first annotation; and save the image with the updated first annotation in a data storage device, wherein the image is for training an artificial intelligence machine for conducting an automated task.

As a person of skill in the art should recognize, embodiments of the present disclosure help reduce costs and expedite the process of performing quality control of image annotations, helping in turn reduce at least some of the bottleneck that may be experienced in training and verifying an AI machine.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a schematic block diagram of a system for automatic detection of annotation errors according to one embodiment;

FIG. 2 is a more detailed block diagram of the one or more error classifiers for classifying annotated images according to one embodiment;

FIG. 3 is a schematic block diagram of example training data that may be used to train a segmentation error classifier according to one embodiment;

FIG. 4 is a flow diagram of a process for evaluating an annotated image for annotation errors according to one embodiment; and

FIG. 5 is a flow diagram of a process executed by an image tagging assistant according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

In general terms, embodiments of the present disclosure are directed to a system and method for providing quality control of annotations automatically. The annotations (also referred to as labels or tags) may be assigned to different objects of an image for using the annotated image for training an AI machine. The AI machine may include, for example, an AI machine used for autonomous/self-driving cars, or for performing different types of computer vision tasks.

In one embodiment, annotations errors are detected automatically via machine learning techniques. Such machine learning techniques may help simplify a potentially complex error detection task by dividing the task into discrete sub-tasks. In one embodiment, a sub-task invokes a specific classifier that is trained to detect a particular type of annotation error. The classifier may include, for example, a deep neural network. The particular type of annotation error may include an incorrect labeling of a particular type of object. For example, if a correct labeling of a pedestrian in an image is via a 2D bounding box around the pedestrian, an error may be detected if another geometric design is detected around the pedestrian, or a 2D bounding box around the pedestrian is larger or smaller than dictated by a bounding box labeling convention.

In one embodiment, one or more of the classifiers are configured to receive an input image and classify a particular type of annotation in the input image (per the classification task that the classifier has been trained for), as correct or incorrect. The one or more of the classifiers may be invoked in a preset or random order. For example, a classifier for detecting 2D bounding box labels may be invoked first, followed by a classifier for detecting a segmentation label, and followed lastly by a classifier for detecting a virtual line label. The classifiers may also be invoked in any other order. In some embodiments, the classifiers are invoked in parallel.

In one embodiment, erroneous labels by the classifiers are collected and provided to an annotation engine for correction. The erroneous labels may also be used for further training of the classifiers. The automatic detection and notification of annotation errors may help reduce at least some of the bottleneck that may be experienced in training and verifying the AI machine.

In one embodiment, detected annotation errors may also be used to learn patterns of objects or elements of images that cause such errors. In this manner, collected images that share one or more of the learned patterns may be identified as being error prone for raising alerts, or for removing such images from the labeling process. When alerts are raised, an error-prone image may be tagged with data that may indicate features (also referred to as characteristics or conditions) of the image that make it prone to annotation errors. With such information, an image processing entity may refrain from selecting the image to be provided to an annotation entity for performing annotations. If the image is selected and provided to the annotation entity, however, the annotating entity may take extra care in performing the annotations in order to minimize the error. The detecting and/or tagging of challenging images may help reduce errors during the annotation phase, highlighting potentially problematic elements in the images. The detecting and tagging of challenging images may also help expedite the training and verifying of the AI machine by, for example, suggesting to the image processing entity that some images may be difficult to annotate, or may contain a pattern that is prone to annotation errors.

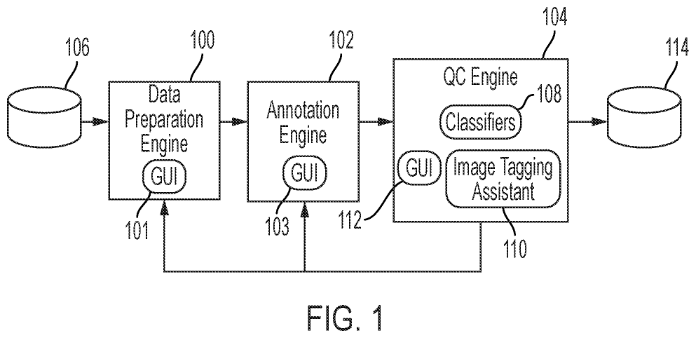

FIG. 1 is a schematic block diagram of a system for automatic detection of annotation errors according to one embodiment. The system may include a data preparation engine 100, an annotation engine 102, and a quality control (QC) engine 104. Although the various engines are, according to one embodiment, assumed to be separate functional units hosted by one or more processing units, a person of skill in the art will recognize that the functionality of the engines may be combined or integrated into a single engine, or further subdivided into further sub-engines without departing from the spirit and scope of the inventive concept.

The data preparation engine 100 may include necessary hardware and software for receiving images from a data store 106, and processing the received images for annotation. The images may include for example, video images captured by a camera and stored into the data store 106. In some embodiments, the images may include static images. Although images that are captured by cameras are used as an example of data that may be collected, selected, and annotated, a person of skill in the art should recognize that embodiments of the present disclosure may extend to other types of data including, for example, point clouds that may be collected by lidars, radar data, and/or other sensor data.

The processing of the images may include selecting images that are to be annotated for training the AI machine. The selection may be manual, automatic, or a combination of both. In one embodiment, the data preparation engine 100 may include a graphical user interface (GUI) 101 that is accessible to a data processing entity. The data processing entity may access the GUI 101 for viewing and selecting one or more images for annotation.

In one embodiment, the data preparation engine 100 receives assistance from the QC engine 104 when processing certain types of images. Such images may include, for example, images that the QC engine identifies as having features that make the images prone to annotation errors. In this regard, the QC engine 104 may provide metadata information (also referred to as tag data) about the error prone images. Based on the received information, the data preparation engine 100 may refrain from selecting the potentially problematic images for annotation, or, if selected, may associate the images with metadata information to aid the annotation of those images. The metadata information may identify one or more characteristics of the image that make it prone to errors. For example, the tag data may indicate that the image contains a crowd of people, a cluster of objects, and/or other features that have been learned over time to cause annotation errors.

The annotation engine 102 may include necessary hardware and software for receiving the selected images from the data selection engine 100, and performing annotations on the received images. The annotating of the images may be manual, automatic, or a combination of both. In one embodiment, the annotating of an image includes adding graphics data for an object or area in the image. The graphics data may include a geometric design such as a box, line, point, cube, and/or the like, on or around an object being annotated, or on/around specific areas of the image. The graphics data may also include color, text, and/or numbers. For example, a pedestrian in the image may be identified by drawing a 2D bounding box around the pedestrian, using dimensions that may be dictated by a drawing convention, as well as with x, y coordinate information identifying the location of the pedestrian in the image, an identifier indicating that the object is a pedestrian (e.g. ID=3), and/or the like. At least some of the graphics data may be stored as annotation data for the image, using one of various file formats, including for example, JavaScript Object Notation (JSON).

In one embodiment, one or more of the selected images received by the annotation engine 102 may include tag data provided by the data preparation engine 100, or additional annotation data that may be created during the annotation. The tag and/or annotation data may be displayed, for example, via a GUI 103 provided by the annotation engine 102. In one embodiment, an annotating agent may adjust an annotating technique used to annotate an image that contains tag data. For example, in response to tag data indicating that the image contains a cluster of objects, an extra fine digital pen may be used to draw a box (or another geometric design) around an object that appears in the cluster.

The annotation engine 102 may also receive messages from the QC engine 104. The messages may include a request to re-annotate an annotated image that is deemed to contain one or more errors. The request may be displayed, for example, on the GUI 103 provided by the annotation engine 102. The request may include, for example, identification of a type of annotation error (e.g. bounding box error, segmentation error, inner line/road edge error, and/or the like), and/or image frame number where the error occurred (e.g. frames 2, 5, 7). In response to the request, the erroneous image frames may be re-analyzed, re-annotated, and re-submitted to the QC engine 104 for quality control.

In one embodiment, the QC engine 104 may include necessary hardware and software for performing quality control of annotated images received from the annotation engine 102. In this regard, the QC engine 104 includes one or more error classifiers 108 for automatically evaluating the annotations, and predicting a likelihood of one or more types of annotation errors based on machine learning. The one or more classifiers 108 may be trained to classify a received annotation using a binary classification scheme. In this regard, the one or more classifiers may be one or more binary classifiers trained to classify an annotation as correct or incorrect.

In one embodiment, the one or more error classifiers 108 include one or more neural networks including, without limitation, a convolutional neural network (CNN), recurrent neural network (RNN), long short-term memory (LSTM), and/or the like. Each machine learning model may comprise various neural network architectures with different number of layers and different number of nodes within each layer of the neural network.

The QC engine 104 may further include an image tagging assistant 110 for identifying images that are predicted to cause annotation errors. In one embodiment, the image tagging assistant may include a neural network, such as a CNN, RNN, LSTM, and/or the like. The neural network included in the image tagging assistant 110 may receive training images with erroneous annotations to learn one or more features of such training images to be able to predict, within a certain level of confidence, whether a particular captured image contains a pattern that is difficult to annotate. The learned one or more features may be associated with one or more metadata tags that may be used to tag the particular captured image that also contains the learned features.

In one embodiment, the image tagging assistant 110 may use information on images that are prone to annotation errors, to assist the data preparation engine 100 in selecting images for annotation. In one embodiment, the image tagging assistant 110 may invoke its neural network to predict whether a collected image in the data store 106 has a feature that has been learned to create an annotation problem. When such a feature is identified in a collected image, the image tagging assistant 110 may forward to the data preparation engine 100, tag data associated with the identified feature for the identified image. In response to receipt of the tag data, the image preparation engine 100 may remove the identified image for being annotated, and/or take another like action, such as including the tag data as metadata for the identified image.

In one embodiment, the QC engine 104 may further include a GUI 112 that is accessible to a quality control entity for interacting with the data preparation and/or annotation engines 100, 102. For example, messages may be transmitted to and from such engines relating to metadata tags, annotation errors, and/or the like.

The GUI 112 may further display notifications/alerts in response to analysis performed by the error classifiers 108. For example, an alert may be displayed by the GUI in response to detecting one or more annotation errors in an image analyzed by the classifiers 108. The alert may indicate the number of errors detected, the frames in which the errors occurred, types of annotation errors detected, and/or the like. The alert may further include a prompt inquiring whether an erroneously annotated frame is to be displayed for further review.

The GUI 112 may also be invoked for displaying quality control statistics gathered by the QC engine 104. The statistics may relate to a total number of images analyzed by the QC engine, a total number/percentage of images containing errors, a total number/percentage of images containing tag data (with further details on the type of tags and images allocated to the tags), and/or a total number/percentage of tagged images that have resulted in annotation errors. Other types of displays and interactions for configuring, running, and evaluating results of the quality control process of the QC engine 104 are also contemplated.

In one embodiment, annotated images and corresponding annotation data and/or tags that are classified by the one or more classifiers as having correct annotations are stored in a data storage device 114. The stored images and associated data may then be used for training and/or verifying the AI machine for conducting an automated task.

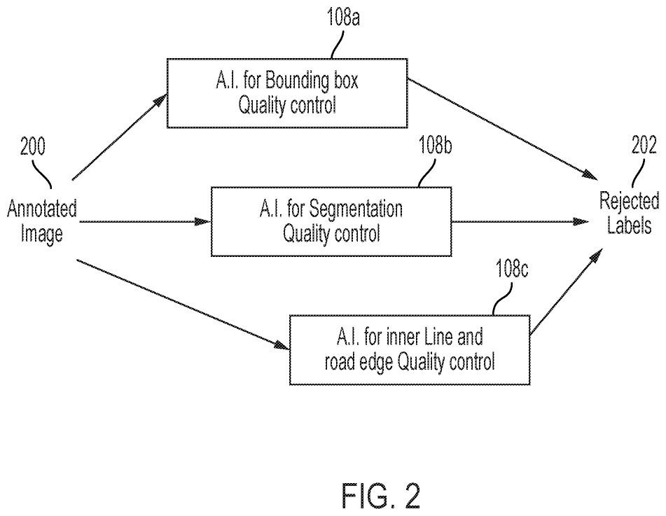

FIG. 2 is a more detailed block diagram of the one or more error classifiers 108 according to one embodiment. In the embodiment of FIG. 2, the error classifiers 108 include a bounding box error classifier 108a, a segmentation error classifier 108b, and an inner line/road edge error classifier 108c. The various classifiers 108 may collectively perform the task of detecting annotation errors in an input image by dividing the error detection responsibility amongst the various different classifiers that are configured with different error-detection sub-tasks. The embodiments of the present disclosure are not limited to the specific classifiers included in FIG. 2, and may include more or less classifiers based on, for example, the AI machine that is to be trained/verified.

In the embodiment of FIG. 2, the bounding box classifier 108a may be trained to perform a sub-task of predicting 2D bounding box labeling errors. In this regard, the bounding box classifier 108a may identify 2D bounding box labels in the annotated input image 200, and classify such labels as correct or incorrect based on the training received using training data relating to bounding box labels. For example, the bounding box error classifier 108b may be trained to classify 2D boxes around images of pedestrians as correct, while classifying 2D boxes around images of non-pedestrians as incorrect.

The segmentation error classifier 108b may be trained to perform a sub-task of predicting segmentation labeling errors. In this regard, the segmentation error classifier may identify segmentation labels in the input annotated image 200, and classify such labels as correct or incorrect based on the training received using training data relating to segmentation labels. For example, the segmentation error classifier 108b may be trained to classify segmentation of cars that do not include wheels as incorrect, while classifying segmentation of cars that include a top, hood, trunk, and wheels, as correct.

The inner line/road edge error classifier 108c may be trained to perform a sub-task of predicting inner line/road edge labeling errors. In this regard, the inner line/road edge error classifier may identify virtual line labels in the input annotated image 200, and classify such labels as correct or incorrect based on the training received using training data relating to virtual line labels. For example, the inner line/road edge classifier may be trained to classify a solid virtual line marking on an edge of a road as correct, while classifying a dashed white line marking between two lanes with opposing traffic as incorrect.

In one embodiment, the various classifiers 108 are implemented as convolutional neural networks. Depending on the sub-task that is being performed, the classifiers 108 may be configured with different filters for abstracting out features of the annotations that are to be detected.

The various classifiers 108 may be invoked serially or in parallel. When invoked serially, the various classifiers may be invoked, one-by-one, randomly or in a particular order. For example, the various classifiers may be invoked one-by-one until a threshold number/percentage of errors are detected, or until all the classifiers have been invoked.

In one embodiment, annotations that are predicted to be incorrect (e.g. within a particular confidence level or value) may be collected as rejected labels 202, and provided to the annotation engine 102 of FIG. 1 for correction. Information about the rejected labels 202 that may be provided to the annotation engine may include, for example, an image frame where the error occurred, type of labeling error, and/or the like. The information about the incorrect annotations may also be used by the image tagging assistant 110 of FIG. 1 for training a machine learning model to tag other images that may share features with the incorrectly annotated images. The information about the incorrect annotations may also be displayed by one or more GUIs (101, 103, 112) for prompting action by a user.

In one embodiment, once the various classifiers 108 have classified the various annotations in the input image 200 as being correct (e.g. within a particular confidence level or value), the image may be deemed to have passed quality control, and may be stored in the data storage device 114 of FIG. 1. The image may then be used to train or verify an AI machine for conducting an automated task.

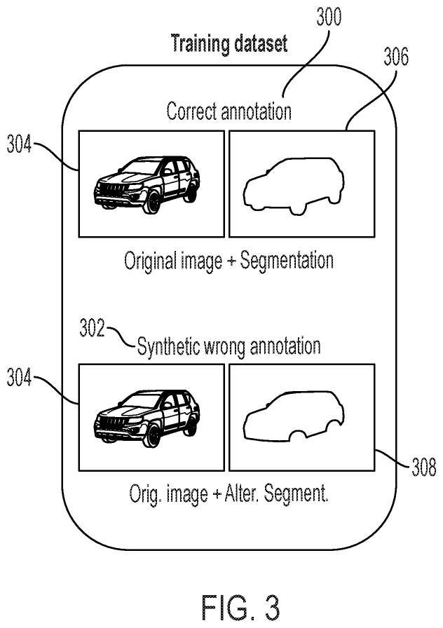

FIG. 3 is a schematic block diagram of example training data that may be used to train the segmentation error classifier 108b of FIG. 2 according to one embodiment. The training data may include an image with a correct annotation 300 as well as the image with incorrect annotation 302. In the example of FIG. 3, the training data includes an image of a sports utility vehicle (SUV) 304 with a correct segmentation label 306 that includes the top, hood, and tires of the vehicle. In training the segmentation error classifier 108b, the correctly annotated training image 300 may be assigned a “correct” classification prior to feeding the correctly annotated image to the classifier for training.

The training data in the example of FIG. 3 also includes the image of the SUV 304 with an incorrect segmentation label 308. The segmentation label is incorrect because it fails to include the tires of the SUV. In training the segmentation error classifier 108b, the incorrectly annotated training image 302 may be assigned an “incorrect” classification prior to feeding the incorrectly annotated image to the segmentation error classifier for training. Once trained with the correct and incorrect segmentations, the segmentation label classifier 108b may classify other SUV segmentation labels that fail to include tires as “incorrect,” while classifying those segmentation labels that include a top, hood, and tires, as “correct.”

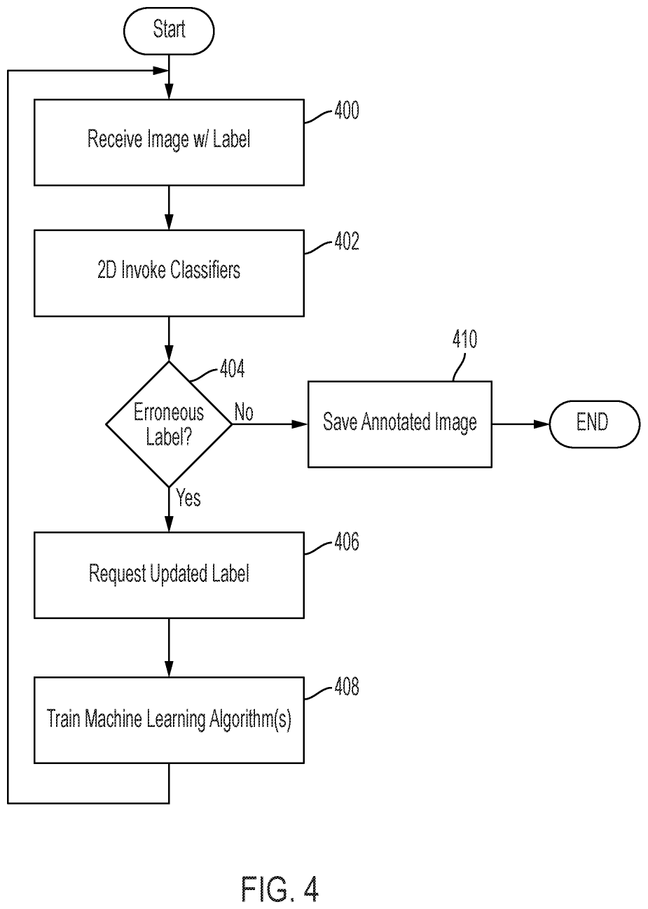

FIG. 4 is a flow diagram of a process executed by the QC engine 104 of FIG. 1 for evaluating an annotated image for annotation errors according to one embodiment. It should be understood that the sequence of steps of the process is not fixed, but can be altered into any desired sequence as recognized by a person of skill in the art.

In act 400, the QC engine 104 receives an image that has been annotated with one or more labels. The labels may be bounding box labels, segmentation labels, virtual line labels, and/or other labels containing graphics data and/or lidar segmentation data, radar data, and/or the like. The graphics data may include a geometric shape on or around the object being labeled, x,y coordinates of the object in an image frame, an identifier of the object, and/or the like.

In act 402, the QC engine 104 identifies and invokes the one or more classifiers 108 of FIG. 1 for performing automatic quality control of the annotated image. The classifiers 108 may be invoked serially or in parallel. In one embodiment, a particular one of the classifiers 108 is trained to perform a binary classification for a particular type of image annotation. In this regard, the particular one of the classifiers 108 may process the received annotation image and predict, based on a particular machine learning algorithm, whether the particular type of image annotation is correct or incorrect. The classification of an analyzed label as “correct” or “incorrect” may be output, for example, with a value indicative of a level of confidence of the prediction. For example, the particular one of the classifiers 108 may indicate that an analyzed label is “incorrect” with a confidence value of 97%.

In act 404, the QC engine 104 determines whether a label analyzed by one of the classifiers 108 is classified as “incorrect.” If the answer is YES, the QC engine 104 transmits, in act 406, a request to the annotation engine 102 for updating the incorrect label. In one embodiment, the update request is sent if the prediction that the label is incorrect, satisfies (e.g. is above) a threshold confidence level. The threshold confidence level may be user configurable. For example, the threshold confidence level may be set to be 90% or higher. In one embodiment, the update request is displayed on the GUI 112 as a suggested action, and a user of the GUI confirms or denies the action. In some embodiments, the update request is not sent if the annotation error is deemed to be minor (e.g. by a user reviewing the annotation error), and/or no more than a preset number of errors have been detected.

In act 408, the incorrect annotation may further be used for training one or more machine learning algorithms. For example, the image with the incorrect annotation may be used for training the machine learning algorithm included in the image tagging assistant 110 of FIG. 1, for tagging error-prone images. The image with the incorrect annotation may further be used to fine-tune the prediction capabilities of the corresponding classifier 108. For example, a user may invoke the GUI 112 to view the incorrect annotation, and provide feedback as to whether the classification was correct or incorrect, and/or include tags describing a feature creating the annotation error. The feedback may be explicit or implied. The feedback may then be used to alter parameters of the corresponding classifier such as, for example, values of the filters used for the convolutional layers of the classifier.

Referring again to act 404, if the QC engine 104 determines that the label analyzed by one of the classifiers 108 is not incorrect, the QC engine may assume that the annotation is correct, and proceed to save the annotated image and associated annotation data and/or tags, in act 410, in the data storage device 114. In some embodiments, the QC engine 104 determines that the label is correct if the prediction can be made within a given confidence value.

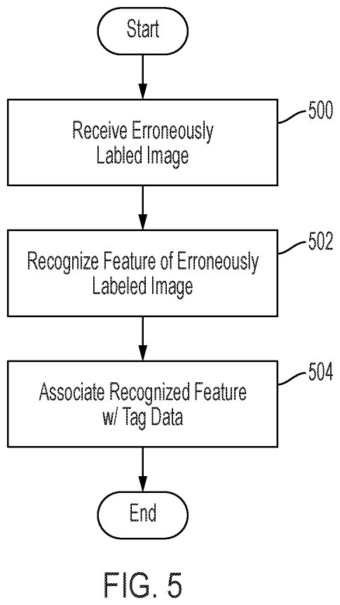

FIG. 5 is a flow diagram of a process executed by the image tagging assistant 110 of FIG. 1 according to one embodiment. It should be understood that the sequence of steps of the process is not fixed, but can be altered into any desired sequence as recognized by a person of skill in the art.

In act 500, the image tagging assistant 110 receives an input image (e.g. one of the collected images).

In act 502, the image tagging assistant 110 invokes its neural network to recognize a feature of the input image predicted to cause annotation errors. The feature may be, for example, a cluster of objects or a crowd of people. The neural network may have been trained to associate such features with annotation errors. In some embodiments, the identification of the feature may be in collaboration with a human operator.

In act 504, the image tagging assistant 110 associates the recognized feature in the input image with tag data. The adding of tag data may be automatic, manual, or a combination of both. For example, upon the neural network of the image tagging assistant identifying a feature in the input image that is predicted to cause annotation errors, a message may be displayed to the human operator to review the feature in the image and add a tag. The tag data may include, for example, a keyword that is learned to be applicable to the recognized feature. In the example of a cluster of objects, the keyword applicable to such a feature may be “cluster.” In one embodiment, the tag data may be associated with the input image by, for example, adding the tag data as metadata of the image. In some embodiments, the adding of the tag data may be the data preparation engine 100 in response to receipt of the tag data from the image tagging assistant. Once tagged, the tag information may be used by different engines of the system including, for example, the data preparation engine and/or the annotation engine 102 of FIG. 1. For example, the data preparation engine 100 of FIG. 1 may determine, based on the tag data, to remove the input image from being selected for purposes of annotation. If the input image is nonetheless selected for annotation, the tag data may be used for displaying alerts or notifications to the tagging entity. For example, a message to take caution when annotating the image may be displayed, along with the keyword contained in the tag identifying the potentially problematic feature of the image.

In some embodiments, the various engines 100-104 of FIG. 1 discussed above, are implemented in one or more processing circuits. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example a processing circuit may include two processing circuits, an FPGA and a CPU, interconnected on a PCB.

The term processor may refer to one or more processors and/or one or more processing cores. The one or more processors may be hosted in a single device or distributed over multiple devices (e.g. over a cloud system).

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although embodiments of a system and method for automatically detecting annotation errors have been specifically described and illustrated herein, many modifications and variations will be apparent to those skilled in the art. Accordingly, it is to be understood that a system and method for automatically detecting annotation errors constructed according to principles of this disclosure may be embodied other than as specifically described herein. The disclosure is also defined in the following claims, and equivalents thereof.

What is claimed is:

1. A method for detecting annotation errors, the method comprising:
receiving, by a processor, an image, wherein the image includes a first annotation;
identifying, by the processor, a first classifier associated with the first annotation;
invoking, by the processor, the first classifier to classify the first annotation, wherein the first annotation is classified with a first label;
transmitting, by the processor, a message in response to classifying the first annotation with the first label, wherein the message is for prompting an update to the first annotation;
receiving, by the processor, the image with an updated first annotation; and
saving, by the processor, the image with the updated first annotation in a data storage device, wherein the image is for training an artificial intelligence machine for conducting an automated task.

2. The method of claim 1, wherein the first annotation includes at least one of graphics data or sensor data.

3. The method of claim 1, wherein the first classifier includes a binary classifier configured to classify annotations with the first label or a second label, wherein the first label is indicative of an incorrect annotation, and the second label is indicative of a correct annotation, and wherein the updated first annotation is classified with the second label.

4. The method of claim 1, wherein the first classifier includes a neural network.

5. The method of claim 1, wherein the artificial intelligence machine is hosted in a self-driving car, and the automated task includes a self-driving task.

6. The method of claim 1, wherein the image includes a second annotation, the method further comprising:
identifying, by the processor, a second classifier associated with the second annotation, the second classifier being different from the first classifier; and
invoking, by the processor, the second classifier to classify the second annotation,
wherein the second annotation is classified with the first label, and
wherein the message includes information on the second annotation for prompting an update to the second annotation.

7. The method of claim 1 further comprising:
learning, by the processor, a feature of the image in response to classifying the first annotation with the first label; and
associating the learned feature with tag data.

8. The method of claim 7, wherein the learning of the feature includes invoking a neural network.

9. The method of claim 7, wherein the tag data includes a keyword associated with the learned feature of the image.

10. The method of claim 7 further comprising:
recognizing, by the processor, the feature in a second image;
associating, by the processor, the tag data to the second image; and
transmitting, by the processor, a message in response to associating the tag data to the second image.

11. A system for detecting annotation errors, the system comprising:
processor; and
memory, wherein the memory contains instructions that, when executed by the processor, cause the processor to:
receive an image, wherein the image includes a first annotation;
identify a first classifier associated with the first annotation;
invoke the first classifier to classify the first annotation, wherein the first annotation is classified with a first label;
transmit a message in response to classifying the first annotation with the first label, wherein the message is for prompting an update to the first annotation;
receive the image with an updated first annotation; and
save the image with the updated first annotation in a data storage device, wherein the image is for training an artificial intelligence machine for conducting an automated task.

12. The system of claim 11, wherein the first annotation includes at least one of graphics data or sensor data.

13. The system of claim 11, wherein the first classifier includes a binary classifier configured to classify annotations with the first label or a second label, wherein the first label is indicative of an incorrect annotation, and the second label is indicative of a correct annotation, and wherein the updated first annotation is classified with the second label.

14. The system of claim 11, wherein the first classifier includes a neural network.

15. The system of claim 11, wherein the artificial intelligence machine is hosted in a self-driving car, and the automated task includes a self-driving task.

16. The system of claim 11, wherein the image includes a second annotation, and the instructions further cause the processor to:
identify a second classifier associated with the second annotation, the second classifier being different from the first classifier; and
invoke the second classifier to classify the second annotation,
wherein the second annotation is classified with the first label, and
wherein the message includes information on the second annotation for prompting an update to the second annotation.

17. The system of claim 11, wherein the instructions further cause the processor to:
learn a feature of the image in response to classifying the first annotation with the first label; and
associate the learned feature with tag data.

18. The system of claim 17, wherein the instructions that cause the processor to learn the feature include instructions that cause the processor to invoke a neural network.

19. The system of claim 17, wherein the tag data includes a keyword associated with the learned feature of the image.

20. The system of claim 17, wherein the instructions further cause the processor to:
recognize the feature in a second image;
associate the tag data to the second image; and
transmit a message in response to associating the tag data to the second image.
